(19) United States
(12) Patent Application Publication
(10) Pub. No.: US 2013/0048653 A1
(43) Pub. Date: Feb. 28, 2013

(54) METHOD AND DEVICE FOR PRODUCING CAN BODIES AND CAN BODIES

(71) Applicant: Werner Boltshauser, Bütschwil (CH)

(72) Inventor: Werner Boltshauser, Bütschwil (CH)

(73) Assignee: COSMOCAN TECHNOLOGY AG, Bütschwil (CH)

(21) Appl. No.: 13/636,878

(22) PCT Filed: Mar. 22, 2011
(86) PCT No.: PCT/CH11/00058

§ 371 Date: Oct. 11, 2012

(30) Foreign Application Priority Data
Mar. 25, 2010 (CH) 434/10

(51) Int. Cl. B21D 51/26; B23P 15/00; B23K 26/24; B65D 6/32

(52) U.S. Cl. 220/679; 29/527.2; 413/74; 413/72

(57) ABSTRACT

A method and device includes Fe producing cans from a directly imprinted metal band. The imprinted metal band can also be subdivided into partial webs prior to further processing by at least one longitudinal cut. An inner coating closed in a circumferential direction can be applied after forming laser seam at the metal band that has been formed into a tubular shape, i.e. prior to severing individual can shells.

### PRIORITY STATEMENT

This application is the national phase under 35 U.S.C. §371 of PCT International Application No. PCT/CH2011/000058 which has an International filing date of Mar. 22, 2011, and which claims priority on Swiss patent application number 434/10 filed on Mar. 25, 2010, the entire contents of each of which are hereby incorporated herein by reference.

### FIELD

At least one embodiment of the invention generally relates to a process for producing cans, to devices for producing cans, and to can bodies for producing cans.

### BACKGROUND

Can bodies are either formed in one piece or in several pieces. With one-piece aerosol cans of aluminum, a cylindrical can body is provided by cold sinking. Subsequently, a narrowed neck portion is formed at the open end by upset-necking. This production process is very sumptuous due to the plant required for many treatment steps and due to the water and energy requirements for cleaning and drying. U.S. Pat. No. 4,095,544 and EP-0 666 124 A1 describe the production of seamless steel cans. In doing this, a cylindrical can body is produced from steel sheet coated with tin or with plastic material by blanking, pressing and ironing. When forming a narrowed can neck, enormous problems may occur, because the material's structure, by ironing, has changed and hardened. With the known one-piece cans, fat and oil residues are on the can's exterior. For forming a decorative layer, cleaning (washing, drying), ground coating (drying), printing and over-painting is performed directly on the outer surface of the receptacle, which is very sumptuous.

DE-199 02 045 and U.S. Pat. No. 6,773,217 B2 describe coating a tinplate band, from which round plates are punched out, and these are formed into can bodies for beverage cans by deep-drawing, a large amount of rejected material resulting between the round-plates and the problems already mentioned with providing a decorative layer.

When imprinting formed aerosol cans, the printing costs may be in the order of the can blank price. Disturbances of the printing machine will result in disruption of can production. Another disadvantage resides in that printing plates or printing cylinders have to be exchanged in the printing machine, when small orders of cans have to be accomplished, which results in discontinuation of a whole production line. The printing machine has to be operated and kept under surveillance by a person skilled in the printing art.

For producing three-piece cans, metal sheets may be imprinted with grid-shaped decoration, and may subsequently be cut into individual body blanks, wherein the body blanks are further processed into can shells. Handling of metal sheets in the known printing procedure is sumptuous and the solvents used are disadvantageous and restrict the location for printing, which leads to undesirable hauling distances. Cutting in two orthogonal directions in correspondence with the respectively desired can height and the corresponding can circumference is troublesome, particularly when changing to cans of different dimensions. Moreover, with the standard metal sheets, there are always sheet clippings in both directions, which cannot be used.

From WO 05/000498, an approach is known, where a tube, closed in peripheral direction, is produced starting from a metal band by a formation step and a welding step, from which shell sections are severed for cans. A can bottom is fixed to every can shell, closed with a longitudinal butt-jointed laser seam, at the lower front side by means of a laser seam. At the upper front side, a necking is formed. Optionally, the upper end of the can shell is restricted by upset-necking or by spin-flow-necking, this necking being able to be effected up to forming the valve seat. A décor layer is applied at the exterior of the can shell in the form of a printed film outside the tube already formed. In order that the film holds sufficiently on the tube, sumptuous precise applying and fixing is required. Optionally, the imprinted film is applied onto the flat metal band already before forming and welding the tube. In this case, undesirable expenses will result when forming the longitudinal laser seam, because the printed film has to be kept away from the laser beam.

WO 05/068127 describes a similar production process, wherein the can shell is additionally pressed radial to the exterior against an inner mold. A decorative film is described, imprinted outside and, optionally, at the inner side facing the can shell with a priming paint, and which is applied to the flat metal band after printing. Above the printed layer at the inner side, a sealing layer is applied, which ensures a firm sealed connection, even through the printed layer, between the film and the metal band. A film web pre-printed and provided with a sealing layer at the inner side in a first printing office, is optionally imprinted at the front side in a further printing step. This further printing step can be carried out at the can producer, in order to apply specific decoration information. This means, for example, that inscriptions, different for the respective sales markets, are applied in a further printing step. Providing and applying the decorative film, thus, implies several treatment steps.

According to EP-0 525 729, a decorative film is wrapped directly in circumferential direction onto a can body and is connected to a closed film wrapping on the can body. Severing and applying a piece of film onto a can body is very difficult with thin films, and involves problems. From documents U.S. Pat. No. 4,199,851, DE-197 16 079 and EP-1 153 837 A1, solutions are known, where shrinkable flat plastic material is wrapped around a wrapping mandrel, are formed to closed wrappings, are shifted as overall labels in axial direction onto bottles or cans and are firmly shrunken. Shifting the overall labels over the bottles or cans implies high deformation and damaging risks, particularly with thin films. Apart from operational and frictional forces, electrostatic charges conditioned by friction may occur, so that rapid transfer of the cylindrically closed film is extremely susceptible to faults.

WO 2004/065273 A2 describes connecting of a piece of film to a closed film wrapping on a concave inner surface, engaged by at least part of the film with an overlapping area. In order to achieve a sealed connection, the overlapping area is pressed to the exterior against the concave inner surface by a pressing ledge, thereby being connected through a sealing connection. The concave inner surface can be pushed together with the film wrapping over a can body without any jamming problems. In this position, the film wrapping is transferred from the concave inner surface to the shell surface of the can body by a shrinkage procedure. The shrinkage procedure is carried out in a furnace. For imprinting the film webs, a transfer process is described. With this, at least one, but preferably various, colors reach a transfer surface, and from the transfer surface in a step onto the film. The imprinted film webs have to be printed and stored in advance up to the moment when they are applied to the cans. This entrains expenditures with planning and storing.

The printing and treating processes for cans are very sumptuous both with imprinting the cans directly and with imprinting and applying films. If films are imprinted, more film sections have to be produced than the cans required, because with applying films onto a metal band or onto the cans, one has to anticipate some scrap. If one prints directly onto the cans, there are rejected cans up to the moment, when a color balance is reached.

For imprinting relative small numbers of paper, digital printing processes are common. Digital processes do not require printing forms to be provided prior to printing. In comparison with printing processes using printing forms, however, they are slow. Since the number of cans to be produced per time unit is very high for a cost-effective production, only very fast printing processes are employed for the can décor and, thus, up to now no digital printing processes. U.S. Pat. No. 5,207,153 describes an approach, where a check mark is printed onto the can shell after applying the can décor using a digital ink jet process.

From U.S. Pat. No. 6,769,357 a solution is known, according to which shell surfaces of can bodies are digitally imprinted, wherein a transport device leads the can shells on work arbors one after the other to printing heads with different colors, and turns them there about the axes of the work arbors by means of motor operators. During the transport from one printing head to the next one, the can shells have to be held in a defined orientation, in order that the different colors deposited in a coordinated manner. The demands to the mechanical transport device with respect to the precise orientation are very high, which results in expensive transport devices. If the orientation is not sufficiently precise, the image quality will be bad.

EP 521 606 B1 describes the production of a three-piece can starting from a steel band, which comprises a film band imprinted by means of gravure printing on one side, and at least one hot-setting layer of plastic material or a thermoplastic resin layer. In order to ensure a good interconnection between the steel band and the imprinted film band, heating devices of large dimensions have to be used, because the high temperature has to act for a sufficiently long period. If the interconnection is insufficient, any deformation, such as forming a restricted can neck, can lead to undesirable deformations of the film.

Transversely to the longitudinal dimension of the steel band, the coatings have a dimension, which is somewhat smaller than the can's circumference. Metal sheets or frames for can shells are severed from the steel band, are subsequently deformed and formed into closed can shells by resistance welding. The welding seam has to be covered by a covering coating. Further processing of the metal sheets, and in particular applying the covering coatings, is expensive.

EP 646 428 A1 describes a similar approach, wherein solely an inner coating is formed, and this by an extrusion device directly onto the flat metal sheet band. With this approach too, further processing of the metal sheets, and in particular applying a seam cover, is expensive.

The current one-piece aluminum cans, for providing an inner barrier inside after washing and drying, are sprayed with a lacquer, which contains a solvent, and which is then dried in a drying furnace, where it releases undesirable solvent vapors. Both the movable spraying nozzle and the washing installations and/or the drying installations, including holding shells for receiving the can bodies, are designed in an expensive manner and are undesirably large.

EP-426 258 B1 describes an approach, wherein closed can shells are formed from metal sheet pieces around a device's arm, and, engaging each other, are guided along the device's arm through an inside coating device. From the side of the device's arm, an artificial resin powder is applied to the inner side of the can shells, is molten and enameled by supplying heat, and is cured by cooling. Preferably, the artificial resin powder is electrically loaded and is applied by a corona. Handling the individual metal sheet pieces and the individual can shells is expensive, particularly artificial resin powder reaches the exterior through the can shells, which results in undesirable soiling.

Document WO 2005/000498 A1 describes an inner barrier in the form of a film, which is applied as a film ribbon onto the metal band prior to forming a tube. The metal band is pre-heated by means of induction heating. Subsequently, the film ribbon is pressed over a deflection pulley onto the metal band, so that a sealing layer of the film ribbon connects the film ribbon with the metal band. A film ribbon comprising a sealing layer is expensive in production. For forming a closed tube, a welding connection is necessary between the two lateral edges of the metal band. Since the film ribbon cannot stand the temperature arising in the region of the welding seam, the film ribbon will not extend laterally up to the margins of the metal band. In order to be able, nevertheless, to form a closed inner barrier, a seam covering band is attached after forming the seam. Supplying and tightly connecting the seam covering band is troublesome, because when forming the welding seam, it must be spaced from it, and is only afterwards pressed to the region of the seam by compressing the formed tube.

### SUMMARY

At least one embodiment of the present invention relates to finding a solution, by which cans could be produced in a simple and cost-effective manner, wherein in particular a decoration of high quality and/or a tight inner coating, having flexibility as high as possible, should be achieved with a simple installation.

For solving this problem, various inventions have been made, which are particularly advantageous in combination. A first invention relates to directly imprinting the metal band. A second invention relates to forming an inner coating, closed in circumferential direction, after forming the laser seam at the metal band formed in a tube-shaped manner, namely prior to severing individual can shells. A third invention relates to the use of at least one digital printing system. All inventions are based on the recognition that slow and fast treatment steps can be combined, wherein however one has to do it without a linear inline-production and, for example, fast treatment steps have to be realized in a single line, and slower ones in parallel lines or simultaneously in several treatment stations. In addition, a metal band imprinted in a fast manner may also be wrapped into a coil, wherein such coils are further processed in parallel with slower treatments. The metal web of a coil may also be subdivided into partial webs by at least one longitudinal cut prior to further processing. In order to be able to satisfy versatile decorative wishes, optionally different printing processes are combined and are used at different places of can production, or a digital printing process is used only when filling the cans.

Within the scope of a first embodiment, it has been recognized, that for imprinting, when producing cans, according to the prior art only two expensive approaches have been considered which indicates a restricting prejudice. For imprinting ready-made cans, very expensive printing devices, sumptuous in handling, are used, which restrict can production to companies for can production. In contrast, imprinting sheets and film ribbons is realized in printing companies, which are designed for special printing. Only with the recognition, that a metal band has to be imprinted directly, a solution has been developed, which enables printing the décor and producing the can at the filling company.

With the approach according to the embodiment, the metal band used for producing can shells, in a printing step, is imprinted with decorative surfaces which in relation to a first direction of the metal band, preferably in the longitudinal direction, extend in the direction of the can axis and extend transversely to the first direction in the direction of the can periphery, at least one longitudinal register mark being arranged in the area of each decorative surface, and the longitudinal register marks enable controlling the severing steps in such a manner, that the severed sections of the metal band comprise each a complete decorative surface. The sections are used as can shells. Preferably, the metal band is closed in circumferential direction already before the severing step by a longitudinal laser butt seam, and subsequently the closed can shells are severed. With some higher expenditure, it is also possible to form sections of the metal band into the shape of a can shell only after the severing step, and to close them in circumferential direction by a longitudinal laser butt seam. The many short longitudinal laser seams may lead to problems at their respective ends, because the heat introduced there is not able to flow away, and local overheating may occur. At one front side of each can shell, a can bottom is fixed.

For imprinting, all known printing processes may be used, at least one offset or flexo printing or silk screen process being preferably used. Since curing or drying of inks, when imprinting, have to be effected very quickly for subsequent further processing or for subsequent winding onto a coil, the ink is preferably cured by means of UV. Over the inks, a covering layer may be applied or printed, which, for example, ensures a smooth surface and some scratch resistance.

The at least one longitudinal register mark in the area of each decorative surface allows the desired control of the severing steps. If a small space is formed between subsequent decors, even a margin of the décor may be used as a longitudinal register mark. However, a characteristic longitudinal register mark imprinted in the décor or, optionally, at the margin of the décor is preferably used.

Since the can shells or the sections for can shells are severed after printing, and since the décor has preferably to extend over the entire height of the can shell, the space between the decors is chosen as small as possible. Optionally, one does even without any space. Therefore, it is very important that the division lines in longitudinal direction of the metal band placed very precisely, which can be achieved with imprinted longitudinal register marks.

Since a laser connection to a can bottom is formed at least at one front side of the can shell, it is advantageous, if a narrow marginal area is free of any décor at the front side. This free marginal area is preferably ensured in that the décor is not printed up to that line, where severing will be executed. It would be possible that the décor in the marginal area is removed with severing or after severing. It has shown that a laser connection is optionally also possible, if the laser beam connects the metallic layer of the can shell to the metallic layer of the can bottom, which engages the interior of the can shell, only after passing the décor or the involved removal of the décor.

If at least two decors are imprinted onto the metal band transversely to its longitudinal direction, the metal band has to be subdivided into a corresponding number of partial webs. Since the two longitudinal sides of each partial web, or optionally of the sections thereof, have to be brought together as a butt-joint, and are interconnected by means of laser welding, it is advantageous; if a narrow marginal area of the can shell is free of décor at the longitudinal sides. This free marginal area is preferably ensured in that the décor is not printed up to the longitudinal sides. It is suitable, if a neat cutting line is formed at both longitudinal sides when subdividing into partial webs or after subdividing. Optionally, the décor is removed in the marginal area, which joins the cutting line or the longitudinal side.

In order that different inks adhere well to the metal band, a primer is preferably applied or printed prior to imprinting. The primer may be focused, on the one hand, to adhering to the metallic surface and, on the other hand, to provide a surface able to be imprinted. If these two tasks cannot be achieved by the same lacquer, a primer may be applied for adhering and on it a covering lacquer for a surface able to be imprinted. Particularly advantageous is a primer which is applied as a metal sheet band coating or a Coil Coating.

With Coil Coating, rolled metal bands are organically coated, wherein a high degree of efficiency of application can be achieved due to the simple geometry. The steps necessary to it are limited to varnishing and drying. Optionally, cleaning, pre-treating and/or post-treating are carried out too. If no fats or oils have been applied on the surface of the metal band, one can do without cleaning. For example, it is possible to apply a first lacquer layer (primer) in a roll procedure, to stove-enamel it at about 240° C., subsequently to apply a second lacquer layer (covering lacquer) again in a roll procedure, and to stove-enamel it again at about 240° C. Afterwards, the metal band may be wound into a coil or may be further processed.

Since the Coil Coating step is realized best directly when producing the metal band, Coil Coating primed metal bands are special products. If such special starting material is necessary for can production, this can result in undesirable shortages or problems. It is suitable to produce cans, starting from metal bands which are available anywhere without any problem. Current steel bands are protected against oxidation by a tin coating or a chrome coating as well as, optionally, by fat or oil. In order to be able to use current metal bands, the metal band is optionally cleaned and/or brushed, and is then directly provided with a ground coat prior to printing. The ground coat may be applied directly by a printing machine, in particular only in the area of the decors to be printed. In doing this, however, the ground coat has to be cured quickly, which is preferably achieved with a ground coat, curing under UV irradiation.

Preferably, Lacquer systems are used which contain solvents, particularly two-component systems (2c-lacquers) with a binder of a resin and a hardening agent. However, systems free of solvents are also possible, for example UV hardening ground coatings. Current lacquer systems are based on polyester and polyurethane (and combinations), epoxy resins and polyvinylidenefluoride (PVDF). Polyurethane lacquers are used as one component systems and two component systems. Curing is effected at room temperature or at elevated temperature. With two component systems, one may use polyisocyanate and a component which contains a polyalcohol. Polyurethane lacquers are particularly suited for a Coil Coating process too. The first lacquers suited for metal ware nitrocellulose lacquers with alkyd resins. Alkyd resins can be combined with many other film formers, for example with phenol resins and epoxy resins. Polyvinyl esters exhibit a good adhesion and adhere well on metallic surfaces. Acryl resins may be used on metal in combination with other resins.

The surface of the ground coating is chosen in a manner that favorable printing processes using favorable printing inks may be employed. For example, a standard offset printing machine (foil rolling cylinder and rubber blanket cylinder) may be used with versatilely used and low priced oil based inks. Apart from heat set roller offset printing inks, water dilutable or UV curable inks can, in some cases, also be used as well as inks with solvents which dry at low temperatures. Apart from offset printing, flexographic printing, packing intaglio printing and silk screen printing can also advantageously be used. With flexo-printing, low viscosity ink (UV curable, solvent based or water based) is carried from a dipping roller to an inking roller, and the inking roller transfers the ink film onto the raised printing form of the printing cylinder. With intaglio printing, the printing form with the indentations is inked by dipping it into low viscosity ink, and any excess of ink is stripped off with a steel knife (doctor blade).

In the field of packaging, one works often with fast colors and, optionally, with primers. For this reason, machines are mostly equipped with a great number of inking systems. In the case of serial multi-cylinder machines, each printing group comprises a separate printing group stand with mating cylinder, and the metal band covers a long drying path between the printing groups. With screen printing, printing ink is printed with a rubber doctor blade through a fine-meshed tissue onto the metal band to be imprinted or onto its lacquer layer. At places of the tissue, where no ink should be printed in correspondence with the print image, the mesh openings of the tissue are made ink impermeable by a stencil. In comparison with other printing processes, velocity is smaller. A great deal of types of inks is offered. They differ, above all, by their adherence properties, stability on different materials and by their drying performance. Due to the great offer of inks, one may optionally use a color, which is able to be applied directly onto metal, and which comprises, to this end, in some cases similar binders as the previously described primer. In order to achieve quick drying and curing of the ink, preferably inks are used , which can be cured by UV light or, in some cases, by electron beams.

Offset printing, above all, is applied, if highest quality requirements as to halftone printing and color fidelity are demanded. In combination with screen printing, hot foil embossed printing or cold foil printing, special effects can be produced. Low priced printing plates or printing rollers with flexible printing plates and a high standardization degree in offset printing make this process also interesting for imprinting simple decors at attractive prices. Everywhere, where high coverage, detail precision and power of colors are required, screen printing is excellently suited. Scented varnishes, thermochromatic inks and glitter inks are only some examples for the field of applications of screen printing. Moreover, any décor can be provided with embossed printing of Braille by screen printing.

For producing round screen printing forms, flexible screen printing plates are used, which obtain the desired color transmissivity by exposing and other treating steps. Processing is equivalent to other photopolymer printing plates, as used for letterpress and flexo-printing. All operative steps can be carried out quickly with a few simple auxiliary devices. From a reprofilm up to a printing form ready for operation, less than 30 minutes are required. Screen printing plates can also be digitally illustrated even without an analogous film.

The imprinted metal band is able to be further processed to closed can shells and further to cans according to any known processes. Particularly advantageously it may be employed for further processing, where it is processed by at least one tube forming installation including a laser welding device into a butt jointed closed tube, from which sections are severed as can shells by means of a severing device. If at least two decors are arranged laterally side by side, the metal band is subdivided into a corresponding number of partial bands, which in transverse direction have only the décor for one can shell. Lateral retrenchment can also be carried out in order to form neat and precise lateral surface of contact. When cutting laterally, the décor together with the primer in a narrow marginal area may be removed, if necessary, in order to uncover the metal layer from outside for the laser seam.

In a preferred embodiment, slots are formed in the metal band on the flat metal band in planes perpendicular to the longitudinal axis of the metal band. These slots, after forming a tube, facilitate severing of can shells or sections, because then severing has only to be effected in the areas without slots. The slots, however, do not extend up to the two lateral marginal areas of the metal band. In the two lateral marginal areas, one foregoes slots, because the laser seam has to be formed there. Preferably, one foregoes a slot also in the middle between the lateral marginal areas. After welding the tube, there are no slots at the laser seam and in the area opposing it with respect to the central tube axis. In these joining areas, drive means, particularly drag crawlers, may frictionally engage the tube and may achieve the feed desired for tube production.

Preferably, the slots are formed directly at the printing machine. They may be used as longitudinal register mark, and allow then the desired control of the severing steps when severing later the tube sections. Optionally, the printing machine comprises also an embossing station, where the metal band is treated by embossing rollers. At the end of the printing machine, a longitudinal cutting device may be arranged, which subdivides the imprinted and slotted metal band into partial bands. The slots are formed in a way, that the partial bands do not have slots at the edges and in the middle. The partial bands may be wound up and stored intermediately, or may be directly further processed in parallel.

To obtain imprinted cans having an inner coating, between the laser welding device and the severing device a circumferentially closed coating is applied to the inner side of the emerging tube. At at least one front side of each can shell, preferably a connection area is formed, to which a closure part can be fixed by means of a laser connection. Optionally, additional décor or information elements are imprinted in the can shell by a digital printing system, wherein this is preferably effected only prior to or after the filling installation and it permits applying specific, particularly individualized, information on the cans.

Within the scope of an embodiment the invention, it has been recognized that the inner coating should be formed at the inner side of the tube after laser welding the emerging tube and prior to severing the can shells, because the seam too is then covered, and it is not necessary to coat each can individually.

Therefore, for producing a can body comprising a can shell and a can bottom, a metal band is moved in its longitudinal direction, is continuously formed in a shaping step at a shaping device into a tube by butt joining the lateral edge surfaces of the metal band, and is closed in circumferential direction at the butt joined lateral edge surfaces in a welding step at a welding device by means of a laser seam. By severing steps at a severing device, sections of the closed tube are severed and made available as can shells having a laser seam. Afterwards, connection steps are carried out, by which a can bottom is fixed at one front side of each can shell. In a treatment area after the welding device and before the severing device, an inner coating step is effected by means of a inner coating device, where a circumferentially closed inner coating is formed at the inner side of the closed tube. Since, in doing this, the seam is covered, one can do without an additional seam covering step.

The thickness of the inner coating mostly is smaller than the thickness of the metal band. A good adhesive connection between the tube wall and the inner coating is important for many applications, because otherwise there is the risk with the severing step, that the inner coating disengages somewhat from the tube. In special applications, it may also be desirable, to achieve only a small adhesive effect between the inner coating and the metal body, in order to be able to separate the components from one another by a defined peeling force. If the inner side of the tube is circular in cross-section and is formed without a shoulder, i.e. butt welded, the extruded inner coating can well be pressed to the inner side, which results in a good connection when extruding sufficiently adhesive plastic material.

In a preferred embodiment, the inner side is provided with an inner coating, preferably of plastic material, particularly of polyethylene (PE) or of a low density polyethylene (LDPE) during the inner coating step, which is converted into plasticized condition by means of an extrusion nozzle. It goes without saying, that the inner coating is respectively chosen in accordance with the specifications for the product to be filled into the can, thus enabling to use, for example, also PET or PP. Extruding and engaging the inner side of a hose-shaped inner plastic layer has the advantage, that no drying or curing step with high temperature has to be carried out. If the inner plastic layer does not adhere to the inner side by itself, adherence has optionally to be achieved by an adhesive or sealing layer previously applied to the flat metal band. In dependence on the contact properties of the inner plastic layer, it may also be sufficient to heat the closed tube prior to applying the inner plastic layer.

Optionally, a layer of bonding agent is applied between the inner side and the inner plastic layer, and is preferably supplied by means of an extrusion nozzle during the step of inner coating. The inner coating may be formed as a mono-layer or as a multilayer construction. In extruding a multilayer or with a co-extrusion, this layer composite would consist of at least one bonding agent and at least one functional layer (two layer co-extrusion). Optionally, the layer of bonding agent or a holding layer for the inner plastic layer is applied onto the metal band already prior to the inner coating step, wherein heat or, optionally, UV light is supplied for drying or curing.

When a hose is applied from an annular extrusion nozzle, a hose-shaped inner plastic layer is extruded and is made to engage the tube's inner side by means of a pressure difference.

In a first group of approaches, a drag plug is arranged in the interior of the tube after the extrusion nozzle, and the inner space of the tube, surrounded by the extrusion nozzle, the drag plug and a portion of the hose-shaped inner plastic layer, is supplied with backing air from the part of the extrusion nozzle. The elevated pressure, developing in this inner space, presses the hose-shaped inner plastic layer against the inner side of the closed tube. In combination with appropriate adhesive properties (bonding agent and/or heat), it is ensured that the inner plastic layer adheres permanently on the inner side of the closed tube. Optionally, the drag plug leads to pressing the inner plastic layer against the inner side of the closed tube.

In a second group of approaches, an under-pressure space is formed in the interior of the tube before the extrusion nozzle and furnishes radial outside the extrusion nozzle an under-pressure, which sucks the hose-shaped inner plastic layer against the inner side of the closed tube.

Instead of the application of a hose, pressure application could be provided, where the coating material is pressed radial against the inner side of the tube by the extrusion nozzle. Since already small variations of the tube's diameter can result in impreciseness of the applied layer, pressure application seems to be less appropriate for this task than the application of a hose.

An extrusion device, apart from the extrusion nozzle, comprises an extrusion tool, at least one melt conduit leading to the extrusion tool, as well as at least one supply conduit and at least one extruder, which feeds a conduit with the material to be extruded. In some cases, a melt pump is interposed between the extruder and the rest. If at least two tubes are produced in parallel, it is suitable to use the at least one extruder for feeding extrusion tools employed in parallel. An extrusion tool is associated to the interior of a developing tube, and is held from that side, where the metal band is still open or the lateral edge surfaces of the metal band are not yet brought together. In the interior of the extrusion tool, interconnections are formed, which lead at least the melt material for the inner plastic layer by at least one conduit to the extrusion nozzle in such a manner, that it can be discharged in hose-shape from an annular discharge opening. Optionally, interconnections are also provided for a bonding agent, which is supplied in a manner that it will be situated between the inner plastic layer and the inner side of the closed tube. The bonding agent is preferably discharged together with the plastic material from one nozzle opening in common. Optionally, the bonding agent is discharged separated from the plastic material out of an individual nozzle opening. Further interconnections in the extrusion tool may be provided for supplying backing air and/or for an under-pressure connection.

The elements of the inner coating device are arranged in a manner, that the inner plastic layer is engaging the inner side of the tube after the welding device. The extrusion tool and the extrusion nozzle may be situated in a region from the shaping device up to after the welding device.

For forming the tube, for laser welding the longitudinal tube seam, for applying the circumferentially closed inner coating and for severing can shells, any metal band may be supplied, particularly also an uncoated and not imprinted one. Optionally, the metal band used comprises a bonding coating for the circumferentially closed inner coating on the later inner side. Preferably however, a metal band is used, which is already imprinted on the later outer side, the décor being preferably imprinted on a primer, and optionally a covering layer is applied over the print. The closed can shells are further processed into cans according to any known method. If at least two decors are arranged laterally side by side, the metal band is subdivided into a corresponding number of partial bands, which in transverse direction have only the décor for one can shell. Lateral retrenchment can also be carried out in order to form neat and precise lateral surfaces of contact. When cutting laterally, the décor together with the primer in a narrow marginal area may be removed, if necessary, in order to uncover the metal layer from outside for the laser seam.

In embodiments, where slots are formed in the flat metal band on the flat metal band in plans perpendicular to the longitudinal axis of the metal band, severing of can shells or sections is facilitated after forming a tube. Severing has only to be effected in the areas without slots. Preferably severing has only to be carried out in two narrow partial areas of the tube's periphery which are opposed to each other with respect to the central tube axis. Since the shell surface of the tube, in these partial areas, deviates only a little from a tangential plan, two severing devices may be used for severing, which oppose each other and extend over the respective narrow area, and which, each from one side, pierce the area to be severed. Since the developing tube is guided by a central mandrel and is continuously in movement along the tube's axis, the severing device comprises cutting elements, which are also moved, in addition to the tube, during their cutting movement.

A simply constructed cutting device comprises a rotating drum having radial protruding cutting edges. The axis of rotation of the drum is orthogonal to the can's axis. The drum's diameter is chosen in a manner that the circumference corresponds to a multiple of the desired length of the tube sections, the cutting edges being in corresponding circumferential distances at the cylindrical outer surface of the drum, and simultaneously in planes parallel to the axis of rotation. For an efficient slotting step, it is suitable, if the cutting edge cooperates with a backing edge of the mandrel. Since the wall thickness of the tube is very small, and the drum's diameter is sufficiently large, the plane of the cutting edge, during the cutting procedure, is almost perpendicular to the tube axis, and the developing line of cut is almost in a plane perpendicular to the tube axis.

If high demands are made that the cutting line is in a plane perpendicular to the tube's axis, and/or if the cutting line extends over a large circumferential portion of the tube, cutting edges having guiding devices may be used, wherein such a guiding device holds the cutting edge together with the joining surfaces of the cutting device during the entire cutting procedure in a plane perpendicular to the tube's axis and, at the same time, moves this perpendicular plane with the speed of the tube's advance. After the severing step, the cutting edge is placed back by the guiding device outside the tube opposite to the direction of advance of the tube. The guiding device may move the cutting edge in an circular-like manner in a cutting plane along the tube's axis, wherein a speed should be ensured, which preferably is substantially constant and coincides with the advancing speed of the tube during cutting in the direction to the tube's axis. The cutting edge does not only move in radial direction, but also in the advancing direction of the tube. During cutting, the cutting edge moves g within the cutting plane with its cutting speed, preferably along a straight line, which has to be understood as small deviation from a circular line.

The backing edge of the mandrel is preferably positioned in a manner that the cutting edge, when impacting the tube's inner side, is in a desired minimum distance to the backing edge. This minimum distance is adapted to the wall thickness of the tube. At the beginning of the cutting procedure, i.e. when the cutting edge penetrates the tube shell, the inner side of the tube shell is somewhat pressed against the mandrel. In order that no friction conditioned braking of the tube shell will result, the surface of contact of the mandrel is formed of a material having a friction coefficient as small as possible, for example of ceramic material. In order to maintain the forces, which act during cutting from the cutting edge to the tube, as small as possible, the cutting edge may be formed or, optionally, moved in such a way, that only part of the cutting edge is in contact with the tube during penetrating, while the other partial regions contact only subsequently. Particularly adapted to this end is, for example, a tooth-shaped cutting edge, wherein the tooth tips are substantially on a segment of a circle, so that at least part of the teeth enters the tube substantially at the same time during penetrating. Advancing and the indentations between the teeth are chosen so that the tube is severed at the end of the cutting procedure over the entire length of the cutting edge.

Now, it has shown that cutting edges, which extend over segments of a circle, are not only usable for severing slotted tubes. Even independently from the inventions protected by the claims, approaches are novel and inventive, which provide a plurality of cutting edges along the tube's circumference for cutting continuously moved tubes, and which may be moved substantially in perpendicular planes to the tube's axis in radial direction to the tube's axis, wherein at the end of the cutting movement, the cutting edges are situated radial within the tube's wall and have completed a closed line. Preferably, the cutting edges cooperate with a backing edge of a mandrel in the interior of the tube. After cutting, the cutting edges are moved again radial to the exterior. The small radial movements of the cutting edges can be carried out in extremely short cycles. When severing with radial moving cutting edges, no chips will develop, and one can do without removing such chips.

With extremely thin-walled metal tubes, one may do, in some cases, without moving the cutting edges in the direction of the tube's axis, in which case the extremely short tube advancement, advanced during the cutting procedure, may be somewhat deformed radial to the interior about the backing edge. If the tube's advancement were affected by cutting edges fixedly positioned in longitudinal direction of the tube, the cutting edges are moved in longitudinal direction of the tube during cutting. To this end, the drum approach, already described for producing slots, or the approach using guiding devices may be employed, wherein such guiding devices keep the cutting edges in a perpendicular plane to the tube's axis during cutting procedure and, at the same time, move this perpendicular plane with the speed of the tube's advancement.

At at least one front side of each can shell, preferably a connection area is formed, to which a closure part can be fixed by means of a laser connection. Optionally, additional décor or information elements are imprinted in the can shell by a digital printing system, wherein this is preferably effected only prior to or after the filling installation and it permits applying specific, particularly individualized, information on the cans.

Within the scope of an embodiment of the invention, which is also advantageous as such alone, it has been recognized that, when producing cans, digital printing systems can be used, which are considered by those skilled in the arts to be too slow and too expensive. Thus, a prejudice, prevailing in the field of production of cans, has been overcome, that is to say that due to economics, very large numbers of pieces of a can having a fixed décor have always to be produced and, thus, only printing processes using printing plates are adequate. When overcoming this prejudice, one had to recognize that production of the can body and preparing the décor can be optimized separately. Albeit the treatment steps for producing cans are realized very quickly, the printing step may nevertheless be carried out in a slower manner, if, for example, it is effected for several cans in parallel or, optionally, only when filling the cans or prior to or after filling. The cans may be produced according to any known method. However, it is particularly advantageous, if the cans are produced in accordance with the first and/or the second described invention.

Imprinting is then effected either with producing cans or with filling using printing systems, which print in parallel, wherein digital printing systems are employed for substantially cylindrical can shells. The current use of digital printing systems is focused on flat surfaces. Thus, a prejudice of those skilled in the art in the field of digital printing had also to be overcome for the present invention. This further prejudice consists in that with digital printing as fast as possible, the product to be imprinted should be imprinted in the form of sheets of bands in the flat form, because in this way faster positioning and a change between printing procedures can be ensured.

When digitally imprinting can shells, the printing heads of a digital printing system are associated to a printing area in common, in order to do without transporting the can shells from one printing head to the next one with a controlled orientation. If the printing heads are associated to a printing area in common, application of all different inks is effected with the same movement of the can shell. The movement of the can shell is either a rotational movement about the axis of the can shell, or a displacement of the can shell in the direction of the axis of the can shell. Since the can shell does not need to be moved from one printing place to the next one, but is completely imprinted in a single printing place, coordination of printing of the different printing heads does not depend on the precision of transport of a can shell from one printing place to the next one.

In the field of digital printing, a true color reproduction of originals or certain standardized hues is made possible, without producing degraded material at the beginning of printing. Directly subsequently, cans having a different décor can be produced. The imprinted décor, in particular, can also comprise a number or a different décor element, which is different on every can, so that cans are emerging having an individualized décor. Changes of imprints can be made in a few seconds by mouse click.

In the field of digital printing, there are several printing technologies, such as ink jet printing, wax printing, thermo-transfer printing, digital screen printing, laser printing and so on, each with corresponding properties. When further processing after printing, there is also a broad choice of coating and protection possibilities. Preferred is digital printing using dry or liquid toners. Ink layers applied in hot condition are mostly very resistant. Wax printing, due to thick ink application, achieves high brilliancy and intensity. Digital screen printing is reasonably priced and fast. Ink jet imprints offer the best resolution and photo quality on special primers. Color laser printers are low priced to purchase and with respect to costs per printed décor.

In order to be able to achieve all colors as well as possible, preferably digital prints are used comprising at least four colors. Preferred are ink printers, for example an ink printer HP mPrinter 400o with five colors. For extremely high requirements, a 7 or 8 color ink printer, for example using HP Vivera inks, may be used. The inks deliver a broad spectrum of brilliant colors for lifelike pictures and black-and white representations with neutral grey hues and a strong black. Using white HP Indigo ink, a silk glossy surface can be printed. Even fluorescent inks could be used. A printing head management system with an electrostatic control of ink drops reduces cleaning requirements and provides a perfect condition of the printing heads.

If an appropriate primer is arranged on the can shell prior to printing, the printing quality, and in particular the light resistance, can be increased. The print is immediately water-repellent, wiping resistant and moisture-proof. With an appropriate primer, the imprint is absolutely waterproof. Preferably, solvent containing lacquer systems are used for the primer, particularly two-component systems (2C-lacquers) including a binder of resin and a curing agent. However, systems free of solvents are also possible. Current lacquer systems are based on polyester and polyurethane (as well as combinations thereof), epoxy resin and polyvinylidenefluoride (PVDF). Due to the constant further development of inks, more and more surfaces may be imprinted without any problem and, therefore, one can do increasingly without a preceding surface treatment of the can shell.

There are digital printing systems where the printing heads are moved to and fro, wherein the can shells to be imprinted are moved in coordination with the movements of the printing heads. Movement of the printing heads occurs substantially in orthogonal direction to the movement of the can shells. If the can shells are rotated step by step about their longitudinal axis during printing, the printing heads are moved to and fro in the direction of the longitudinal axis, the respective movement depending upon whether the ink of the printing head is required in the corresponding area of the can shell. If the can shells, during printing, are displaced in the direction of their longitudinal axis, the printing heads are moved in circumferential direction about the longitudinal axis, the respective movement depending upon whether the ink of the printing head is required in the corresponding area of the can shell.

It goes without saying that moved printing heads can preferably be arranged on a system of movement in common. The movement of the printing heads has to be carried out in such a manner, that the printing heads are guided to all places where at least one ink has to be applied. If a separate system of movement is provided for every printing head, the movement of individual printing heads is limited to areas, where the corresponding ink is required. Once all printing heads have imprinted the assigned area of the can shell, the can shell may be moved further.

One can do without any movement of the printing heads, if the printing heads span the whole extension of the printing area, i.e. height or circumference of the can shells. Linear printing heads may be longer than the can height to be imprinted, wherein then it is ensured by a printing control that printing is limited to the desired height of the can shell. With annular printing heads, which are adapted to the circumference of the can shell, for different can diameters, corresponding printing heads have to be used.

If linear printing heads for different inks are distributed (or somewhat offset) in circumferential direction around an axis of rotation, printing of all inks is optionally effected simultaneously during rotation of the can shell, wherein the printing heads apply picture portions being offset in correspondence with their distance in circumferential direction. If the succession is important when applying, one ink after the other may also be applied, the can shell having to be rotated several times about its axis. With cylindrical can shells, the linear printing heads are straight. For rotation symmetrical can shells, which deviate from a cylindrical shape, it would, however, likewise be possible to use correspondingly shaped linear printing heads wherein, however, for each shell shape printing heads have to be provided.

If circular printing heads are offset in axial direction centrally about an advance axis, printing of the different colors of corresponding picture areas by the various printing heads occurs in a somewhat time-staggered way during the movement of the can shell along the advance axis, time-staggering depending upon the advancing speed and the distance between the printing heads.

Substantially simultaneously imprinting or in parallel of several can shells may be carried out with turn tables which, however, is relative expensive due to the synchronized handover operation and the holding and handover elements harmonized with the diameters of cans. In addition, a turn table, on which many can shells are imprinted substantially simultaneously, has a large diameter and needs much space.

Imprinting of can shells is optionally carried out on can shells without a can bottom and without an upper closure or without upper necking. In particular, cylindrical can shells are imprinted. To this end, the installation for imprinting is arranged between the installation for producing closed can shells and the installation for attaching a can bottom. Preferably, however, cans ready for filling or already filled are imprinted.

The throughput required for imprinting is achieved with approaches, where several linear printing lines are provided in parallel. In front of the printing lines, congestion regions are provided, from which the can shells to be imprinted are guided into the parallel printing lines. If the production is changed from cans having a first diameter to cans having a second diameter, only a few elements have to be adapted to the changed diameter at the feeders to the parallel printing lines. In case of problems with one printing line, it is not the whole can production which has to be stopped, but it is only the congestion region, which has to be filled somewhat more.

For imprinting can shells, the same are preferably put onto pallets directly after production, by means of which they can be conveyed from the area of can shell production, through a congestion area in front of the printing lines, through the printing lines and afterwards to the next treatment step of can production. For conveying the can shells, preferably pallets having magnetic material and magnet conveyors are used, or with a material, which is spontaneously not magnetic, but is able to be magnetized. The pallets comprise areas formed for the contact with deflection surfaces of the conveyors and other guidance elements. Preferably, the pallets are formed in a mandrel shape and, thus, are formed as an inner supporting structure for the can shells, which ensures the necessary stability for printing and the holding devices required for the printing lines.

The treatment steps of the can parts are able to be carried out substantially independently from the printing lines. Only if a big part of the printing lines has problems, can production, in some cases, has to be stopped. It is suitable to provide more printing lines than necessary for the throughput of the can production. In this way, undesirable jamming in front prior to printing can be prevented.

In the case of parallel printing lines, the individual lines may print different decors and the deliver the imprinted can shells separately to further processing. Preferably, the imprinted can shells, after the printing line, end up in a congestion region in common, from which they are supplied to the next can production step.

Optionally, imprinting is done only directly prior to, at or after filling the cans wherein, in some cases, only part of the décor is printed at that place.

### BRIEF DESCRIPTION OF THE DRAWINGS

The drawings explain the approach according to the invention with reference to embodiments. There is illustrated in

FIG. 1 shows a schematic representation of the steps and devices used for producing a décor on cans,

FIG. 2 shows a schematic representation of the steps and devices used for producing an inner coating on can shells,

FIG. 3 shows a schematic cross-sectional view for forming a longitudinal seam,

FIGS. 4 to 7 show schematic cross-sectional views of inner coating devices,

FIG. 8 shows a schematic representation of the steps and devices used for producing can shells having a décor and an inner coating,

FIGS. 9a and 9b show a front view and a lateral view of a drum having cutting edges for severing tube sections,

FIGS. 10a and 10b show a lateral view and a front view of two drums having cutting edges for severing tube sections,

FIG. 11 shows a schematic representation of a printing device,

FIGS. 12a, 12b, 12c show schematic cross-sectional views of a severing device including a guiding device for moving the cutting edge in a plane perpendicular to the tube's axis, the plane being moved together with the tube,

FIGS. 13a, 13b, 13c show a front view of the tube and the cutting edges movable in radial direction with respect to the tube's axis,

FIGS. 14a, 14b, 14c show a lateral view of the tube and the cutting edges movable in radial direction with respect to the tube's axis, and

FIGS. 15a, 15b show a front view of the tube and the cutting edges with teeth prior to and after cutting the tube.

### DETAILED DESCRIPTION OF EXAMPLE EMBODIMENTS

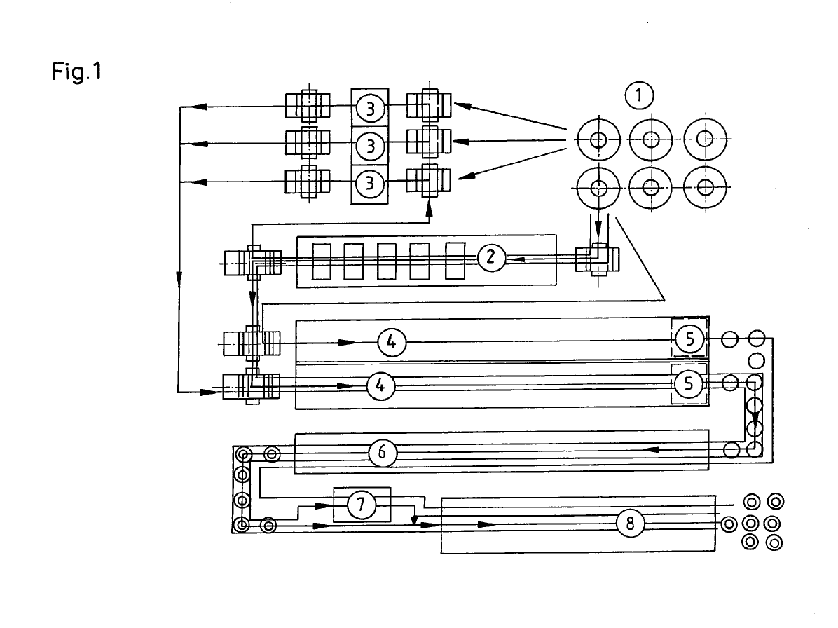

FIG. 1 shows a device, that enables efficient and versatile production of a décor of cans. Metal bands 1 are fed to a desired printing line. A printing device 2, having cylindrical printing plates, imprints the metal band with a desired number of colors. In doing so, décor surfaces and longitudinal register mark will come into existence wherein, in a first direction of the metal band, preferably in its longitudinal direction, the décor surfaces exhibit a height dimension of the can décor in the direction of the can's axis, and exhibit the circumferential can décor transversely to the first direction. The longitudinal register marks are situated in the area of the décor surfaces. In some cases, first a primer is applied by at least one printing plate. For intensely individualized prints or for small series, digital printing systems 3 are used. Since these print in a slower manner, it is suitable in some cases to imprint several bands in parallel. If required, a metal band imprinted by the printing device 2 is fed to a digital printing system 3 for applying small supplements.

An imprinted metal band is supplied to a shaping device 4 including a first laser welding device and a severing device. Therein, the metal band is moved in its longitudinal direction and, in a shaping step, is formed continuously to a tube by bringing the lateral edge surfaces of the metal band in butted form together. In a welding step at the laser welding device, the shaped tube is closed in circumferential direction by a longitudinal laser seam at the butt joined lateral edge surfaces. In severing steps with a severing device 5, sections of the closed tube are severed. For cans to have an inner coating, after the welding device and before the severing device the metal band is provided with an inner coating, which adheres to the inner side of the closed tube, and which is closed in circumferential direction, thus covering the seam.

In an attachment device 6a can bottom is fixed at one front side of each can shell. Optionally, the upper can end too is formed in correspondence with the desired can type. A further digital printing system is designed to imprint a can shell over a printing height and the entire circumference of the can. To this end, all inks of the at least one digital printing system are applied on the can shell within a time interval in common and at one course of movement in common of the can shell relative to the further digital printing system 7 by corresponding printing heads in the respectively required proportions, wherein all printing heads of the further digital printing system are assigned to a printing area in common, in which printing area the can shell is located during the course of movement. The completely imprinted cans are filled in a filling installation 8 and are closed.

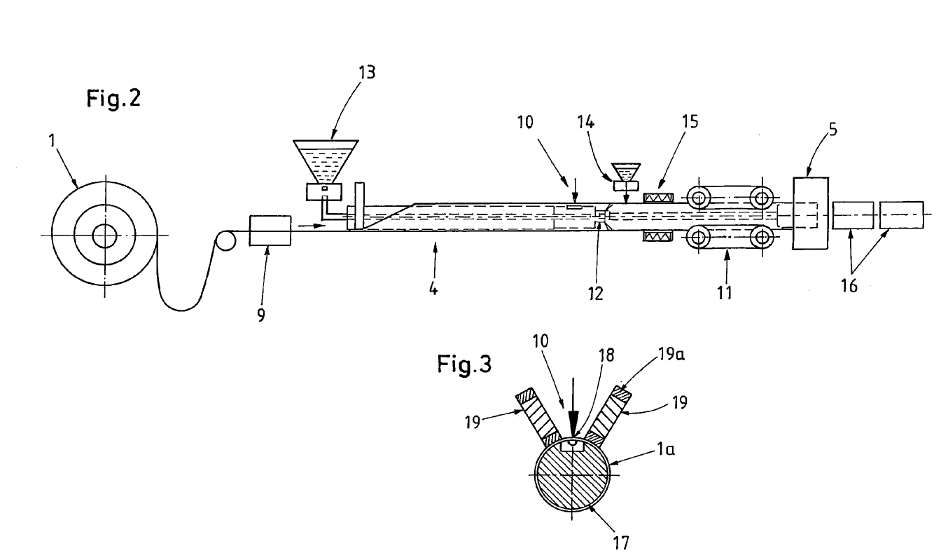

According to FIG. 2, the metal band 1 is fed through a device 9 for trimming the lateral edges, and to the shaping device 4 including the first laser welding device 10 and the severing device 5. The metal band 1 is moved in longitudinal direction by a drag crawler arrangement 11. At the supply side of the laser welding device 10, the metal band 1, in a shaping step is formed continuously to a tube by bringing the lateral edge surfaces of the metal band in butted form together. In a welding step at the laser welding device 10, the shaped tube is closed in circumferential direction by a longitudinal laser seam at the butt joined lateral edge surfaces.

For cans to have an inner coating, the metal band 1 is coated with an inner coating before the severing device 5 by an inner coating device 12. The produced inner coating adheres to the inner side of the closed tube, is formed in a closed shape and, thus, covers the longitudinal laser seam. The coating material for the inner coating reaches the inner coating device 12 from a feeding device 13 through the interior of the formed metal band.

For covering the longitudinal laser seam at the outer side, an outer seam coating device 14 is arranged between the first laser welding device 10 and the severing device 5. In order that the inner coating and, optionally the outer seam cover, attaches well to the metal band, a heating device 15 is used. A can bottom is fixed at the front side of each can shell 16, which is coated in its interior and provided with a décor on the outer side, by a second laser welding device.

FIG. 3 shows a cross-section at the laser welding device 10. In the interior of the band material 1a, circularly shaped in peripheral direction, there is a mandrel 17, which leaves a free space in the region of the longitudinal laser seam 18. In order that two lateral edges of the extremely thin band material la butt-join precisely each other, pressing rollers 19 are provided at both sides of the longitudinal laser seam 18. The pressing rollers 19, in the case of band material la capable of being magnetized, may be quipped with magnets 19a, so that the band material la can be held precisely also on the pressing rollers, thus being able to do without firmly pressing on the mandrel 17, which would produce friction. Conduits for the inner coating not shown extend through the mandrel and optionally ones for supplying or evacuating gas from the region of the laser welding device 10.

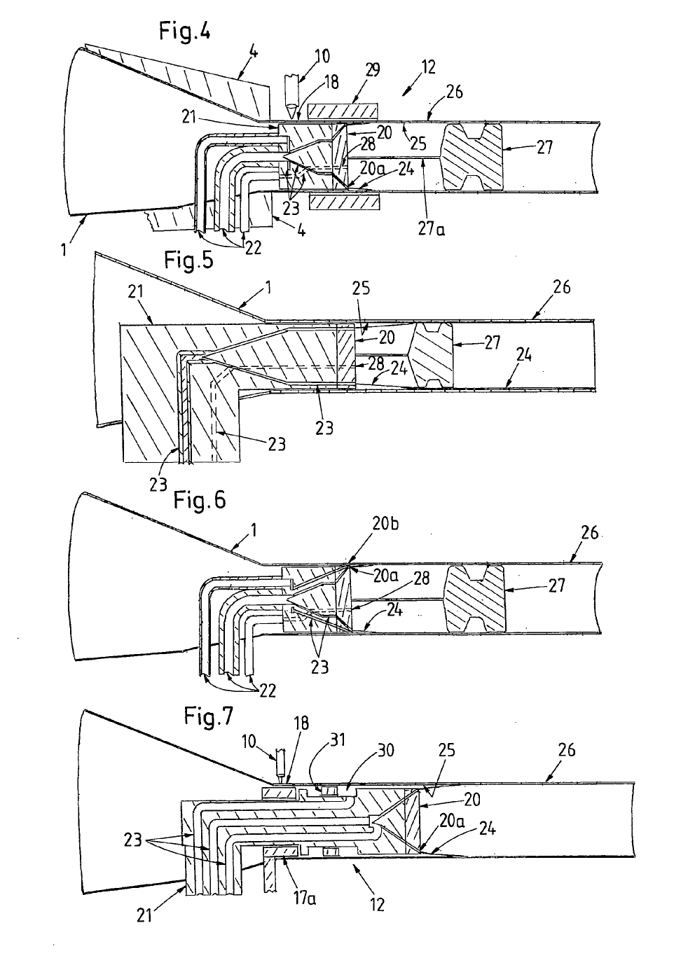

FIG. 4 shows an inner coating device 12 for coating the interior of the tube produced from the metal band 1. The metal band 1, by a shaping device 4, is formed continuously into a tube by bringing the lateral edge surfaces of the metal band 1 in butted form together and is closed by a laser welding device 10.

In the embodiment shown, the inner coating device 12 is formed as an extrusion device and comprises an extrusion nozzle 20, an extrusion tool 21, at least one conduit 22, which leads into the extrusion tool 21, and at least one extruder, not shown, which feeds at least one conduit with the material to be extruded. The extrusion tool 21 and the extrusion nozzle are assigned to the interior of the developing tube, and are held from that side where the metal band 1 is still open.

In the illustrated embodiment, the extrusion tool 21, in the region of the laser welding device 10, cooperates with the shaping device 4 and takes the function of the mandrel 17 according to FIG. 3 over, which leaves a free space in the region of the longitudinal laser seam 18.

In the interior of the extrusion tool 21, connections 23 are formed, which direct material for the inner coating from a conduit 22 to the extrusion nozzle 20 in such a manner, that the material is discharged as a hose-shaped closed inner coating 24 through an annular output opening 20a. In the embodiment shown, a conduit for a bonding agent is represented radial outside the central conduit 22 and is arranged radial outside around the centrally fed coating material by an annular connection 23. The components thus combined reach the extrusion nozzle 20 through conically extending connections 23. The bonding agent is at the outer side of the hose-shaped inner coating 24 and ensures good adherence of the inner coating 24 to the inner side 25 of the tube 26.

The hose-shaped inner coating 24 is preferably brought to engage the inner side 25 of the tube 26 by means of a pressure difference. For achieving the desired pressure difference, a drag plug 27 is arranged in the interior of the tube after the extrusion nozzle 20, and the inner space of the tube, surrounded by the extrusion nozzle 20, the drag plug 27 and a portion of the hose-shaped inner coating 24, is supplied with backing air via a conduit 22, a connection 23 and a backing air duct and through the extrusion nozzle 20. The increased pressure developing in this inner space presses the hose-shaped inner coating 24 against the inner side 25 of the closed tube 26. Optionally, the tube 26 is heated in the area of the inner coating device 12 by a heating device 29, particularly an induction heating unit, in order to improve adherence of the inner coating 24. The use of a bonding agent and/or of the heating device 29 ensures, that the inner coating 24 adheres to the inner side 25 of the closed tube 26 in an enduring manner. The drag plug 27 is fixed to the extrusion nozzle 20 by means of a holding connection 27a.

FIG. 5 shows an embodiment comprising an extrusion tool 21 which, in the region of the not yet closed metal band 1, extends radial outwards from the interior of the tube. In a connection 23, the coating material, and directly engaging it, a bonding agent is supplied. The hose-shaped inner coating 24, leaving the extrusion nozzle 20, is pressed against the inner side 25 of the tube 26 by the drag plug 27. In this embodiment, the tool may be located even far in front of the closed metal band 1, so that an extruded, particularly solidified, plastic hose is guided into the shaped metal band 1. In the region after welding the metal band, the hose-shaped closed inner coating 24 is attached to the tube's inner side 25 by supplying heat and by means of an overpressure.

FIG. 6 shows an embodiment, where the extrusion nozzle 20 comprises a first and a second annular discharge opening 20a, 20b, the material of the inner coating leaving the first discharge opening 20a, and the bonding agent leaving the second discharge opening 20b. The connections 23 are correspondingly formed and connected to the conduits 22.

FIG. 7 shows an embodiment, where in front of the extrusion nozzle 20 in the interior of the tube an under-pressure space 30 is formed, which provides under-pressure outside the extrusion nozzle 20, thus sucking the hose-shaped inner coating 24 against the inner side 52 of the closed tube 26. The under-pressure space 30 is closed at one side by a sealing 31, and at the other one by the hose-shaped inner coating 24. Under-pressure is produced by a vacuum pump connected to the under-pressure space 30 via a connection 23. Two other connections 23 serve for supplying the bonding agent and the coating material, both components being combined only shortly before the extrusion nozzle 20 in such a manner, that the bonding agent, having left the extrusion nozzle 20, faces the inner side 25 of the tube 26.

The elements of the inner coating device 12 are arranged in such a manner, that the inner coating 24, after the laser welding device 10, engages the inner side 25 of the tube 26. Optionally, instead of the mandrel 17, a sleeve 17a is arranged about the extrusion tool 21, the sleeve 17a comprising a free space in the region of the longitudinal laser seam 18. In order that the two lateral edges of the extremely thin metal band 1 are butt-joined in a precise manner at the longitudinal laser seam 18, pressing roller, not shown are, for example, provided at both sides of the longitudinal laser seam 18.

It goes without saying that in the embodiments of FIGS. 5 to 7 too, a respective shaping device not shown (analogously to FIG. 4) is provided. In FIGS. 5 and 6 the existing laser welding device has not been drawn in, but as in FIG. 4 or 7 would be positioned in the region of the extrusion tool 21 or of a sleeve 17a. After applying the inner coating, sections 16 of the closed tube 26 are severed in severing steps at a subsequent severing device 5 (FIG. 2).

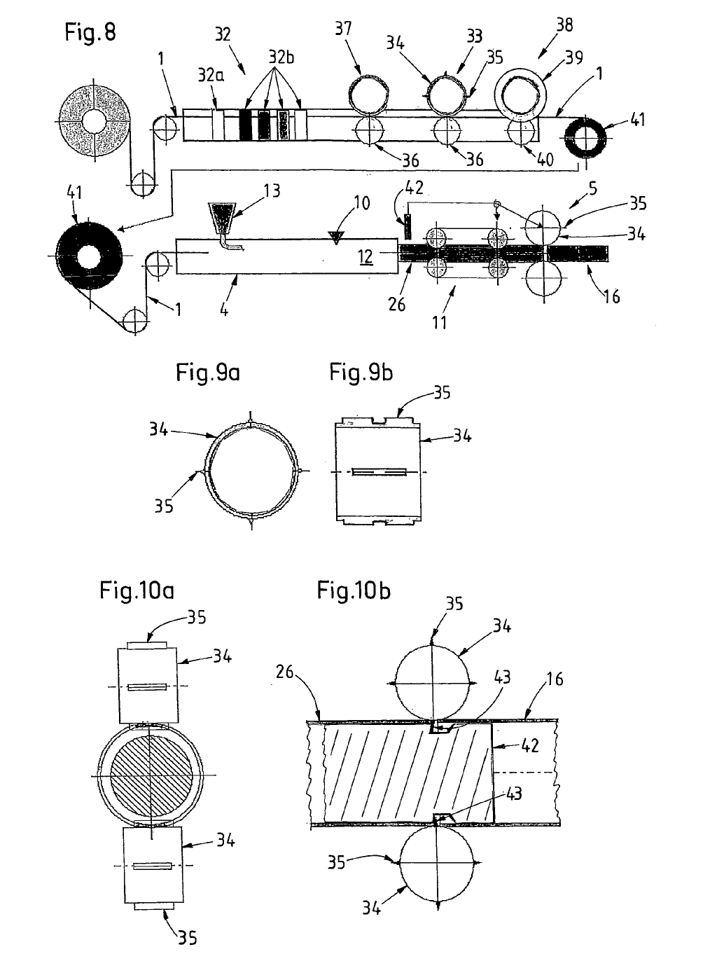

FIG. 8 shows an embodiment comprising a printing machine 32 for printing décor surfaces, and a treatment section including a shaping device 4, a laser welding device 10, an inner coating device 12, a feeding device 13 for coating material, a drag crawler arrangement 11 and a severing device 5. In addition to the printing steps 32b, optionally a priming step is carried out at the printing machine 32.

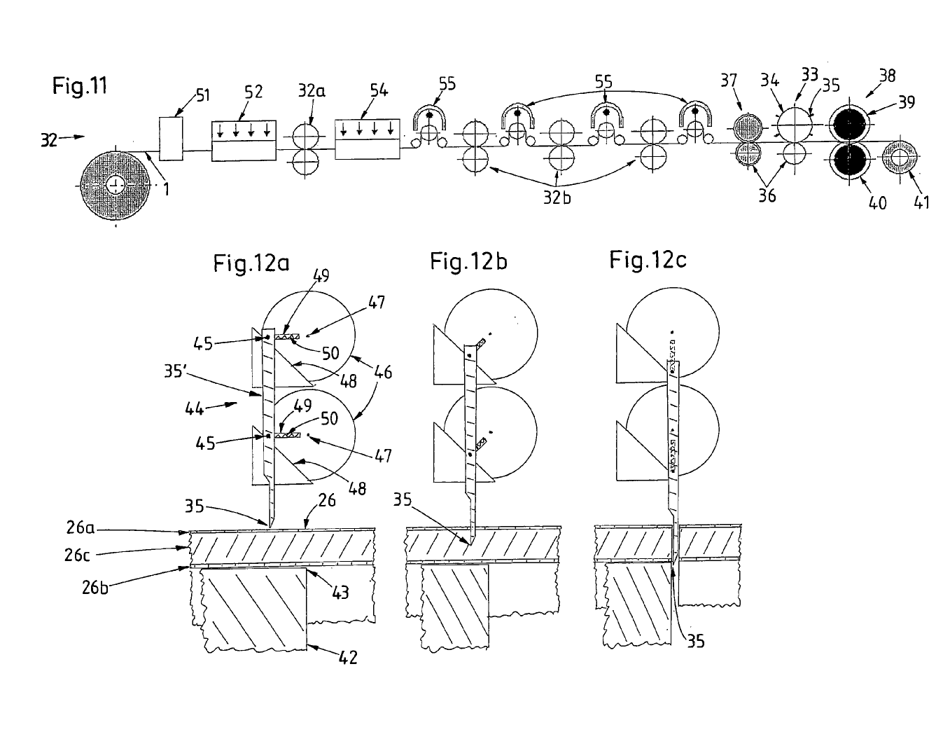

FIG. 11 shows details of the printing machine 32. In some cases, a cleaning station 51 is provided, in which the surface to be imprinted of the shell band 1 is cleaned or treated in such a manner, that the first layer to be applied adheres in a sufficient stable manner on the metal surface. The treatment may comprise washing, brushing and/or other mechanical treatments. Optionally, a laser treatment or a plasma treatment is provided.

After a primary drying step 52, optionally being provided, primer varnishing 32a may be carried out. In correspondence with the primer used, warm air drying 54 and/or UV drying 55 is provided. After each one of the various printing steps 32b, UV drying 55 is preferably carried out.

According to FIGS. 8 and 11, the printing machine 32, in a preferred embodiment, comprises a slotting device 33, which forms slots in the flat metal band 1 in planes perpendicular to the longitudinal axis of the metal band. These slots, after shaping the tube, facilitate severing of can shells or sections, because then severing has only to be done in the areas without any slot. In both lateral marginal areas of the metal band, one should do without slots, because there the longitudinal laser seam has to be formed. Preferably, one abstains from a slot in the middle between the two lateral marginal areas. The slots may be used as longitudinal register marks when later severing the tube sections 16.

Part of a simply constructed slotting device 33 is represented at a larger scale in FIGS. 9a and 9b. The slotting device 33 comprises a rotating drum 34 having radial protruding cutting edges 35. The axis of rotation of the drum 34 is arranged orthogonally to the longitudinal axis of the metal band 1. The drum's diameter is chosen in a manner that the circumference corresponds to a multiple of the desired length of the tube sections 16, the cutting edges being in corresponding circumferential distances at the cylindrical outer surface of the drum 34, and in planes parallel to the axis of rotation. For an efficient slotting step, it is suitable, if the cutting edge 35 cooperates with a supporting roller 36, wherein preferably the cutting edges 35 cooperate with backing edges of the supporting roller. Since the wall thickness of the tube 26 is very small, and the drum's diameter is sufficiently large, the plane of the cutting edge, during the cutting procedure, is almost perpendicular to the metal band 1.

Optionally, the printing machine 32 comprises also an embossing station 37, where the metal band is, for example, treated by embossing rollers. The embossing station 37 comprises a rotating drum with curved embossing surfaces, which, when embossing, are assigned to the already printed décor surfaces. The axis of rotation of the drum is arranged orthogonally to the longitudinal axis of the metal band 1. The drum's diameter is chosen in a manner that the circumference corresponds to a multiple of the desired length of the tube sections 16, the embossing surfaces being correspondingly arranged on the cylindrical outer surface of the drum. For a good embossing step, it is suitable, if the embossing surfaces cooperate with a somewhat elastic backing roller 36 or with a backing roller having backing surfaces which conform to the embossing surfaces.

At the end of the printing machine 32, a longitudinally cutting device 38 may be arranged, which subdivides the imprinted, slotted and optionally, embossed metal band 1 into partial bands 41. The longitudinally cutting device 38 comprises at least a first cutting ring 39, which, in some cases, cooperates with a second cutting ring or a backing ring 40. The partial bands 41 may be wound up and temporarily stored, or they may be further processed directly in parallel.

In FIG. 8, further processing of the imprinted and slotted metal bands 41 is illustrated. By the shaping device 4, the imprinted metal band is closed in tube shape. By the laser welding 10, the longitudinal seam is formed. By the inner coating device 12, the inner coating is applied. There are no slots at the laser seam and in the area opposite with respect to the central tube axis. In these connected areas, the drag crawlers 11 will frictionally engage the tube 26, thus achieving the desired advancement for tube production.

A register mark reading device 42 recognizes the register marks and slots and controls the severing device 5, and optionally the drive of the drag crawlers 11. The severing device 5, after shaping the tube, severs can shells 16 or sections.

FIGS. 10a and 10b show a simple severing device 5. Severing has only to be done in the areas without slots. Preferably, severing has to be done only in two narrow partial areas of the tube's circumference, each opposite with respect to the central tube axis. Since the shell surface of the tube 26, in these partial areas, deviates only a little from a tangential plan, two severing devices may be used for severing, which oppose each other and which pierce the area to be severed. Since the developing tube 26 is guided by a central mandrel 42 and is continuously in movement along the tube's axis, the severing device comprises cutting edges 35, which are also moved, in addition to the tube 26, during their cutting movement.

The schematically illustrated (not to scale) severing device comprises rotating drums 34 having radial protruding cutting edges 35. The axis of rotation of the drums is orthogonally arranged to the tube's axis. The drum's diameter is chosen in a manner that the circumference corresponds to a multiple of the desired length of the tube sections 16, the cutting edges 35 being in corresponding circumferential distances at the cylindrical outer surface of the drum 34, and in planes parallel to the axis of rotation. For a good severing step, it is suitable, if the cutting edge 35 cooperates with a backing edge 43 of the mandrel 42. Since the wall thickness of the tube 26 is very small, and the drum's diameter is sufficiently large, the plane of the cutting edge 35, during the cutting procedure, is almost perpendicular to the tube's axis and the emerging cutting line, and the emerging cutting line is in a plane perpendicular to the tube's axis.

FIGS. 12a, 12b and 12c show a severing device 5, where the cutting edge 35 is moved over a guiding device 44, wherein such a guiding device 44 holds the cutting edge 35 in a plane perpendicular to the tube's axis during the whole cutting procedure, and this perpendicular plane moves with the speed of the advancing tube. After the severing step, the cutting edge 35 is returned outside the tube opposite to the direction of advance of the tube by the guiding device 44. The guiding device 44 is able to move the cutting edge similarly to a circle in a cross-sectional plane along the tube's axis, wherein a speed should be ensured, which preferably is substantially constant and coincides with the advancing speed of the tube during cutting in the direction to the tube's axis.

In order to achieve this, the cutting knife 35′ with the cutting edge 35, in this embodiment, is connected in two spaced connection points 45 each with synchronously rotating disks 46. The distance of the two disk rotational centers 47 corresponds to the distance of the two connection points 45. To ensure, that the speed component of the cutting edge 35 in the direction to the tube's axis is constant, straight guiding lines 48 are provided for the connection points 45. In order that the connection points 45, at the rotational movement of the disks 46, are able to follow these guiding lines 48, the connection points 45 are held on the disks 46 in radial guidances 49, wherein spring elements 50 hold the connection points 45 in the possible extreme position.

In the magnified illustration of the tube 26, outside is represented the printing layer 26a, inside the inner coating 26b, and in-between the metallic can wall 26c. The backing edge 43 of the mandrel 42 is preferably positioned in a manner that the cutting edge 35, when striking the tube 26 (FIG. 12a), still is in the region of the mandrel 42. When penetrating further into the tube 26 (FIG. 12b), the cutting edge 35 moves together with the tube 26 against the backing edge 43, so that it is at a desired minimum distance to the backing edge when attaining the tube's inner side (FIG. 12c). This minimum distance is adapted to the wall thickness of the tube 26. At the beginning of the cutting procedure, i.e. when piercing the cutting edge 35 into the tube shell, the inner side of the tube shell is somewhat pressed against the mandrel 42. In order that no friction conditioned braking of the tube shell will result, the surface of contact of the mandrel 42 is formed of a material having a friction coefficient as small as possible, for example of ceramic material.

In order to maintain the forces, which act during cutting from the cutting edge to the tube, as small as possible, the cutting edge may be formed or, optionally, moved in such a way, that only part of the cutting edge is in contact with the tube during penetrating, while the other partial regions contact only subsequently. Particularly adapted to this end is, for example, a tooth-shaped cutting edge 35 illustrated in FIG. 15a at the beginning and in FIG. 15b at the end of a cutting procedure. The tooth tips are substantially on a segment of a circle, so that at least part of the teeth enters the tube substantially at the same time during penetrating. Advancing and the indentations between the teeth are chosen so that the tube 26 is severed at the end of the cutting procedure over the entire length of the cutting edge 35.

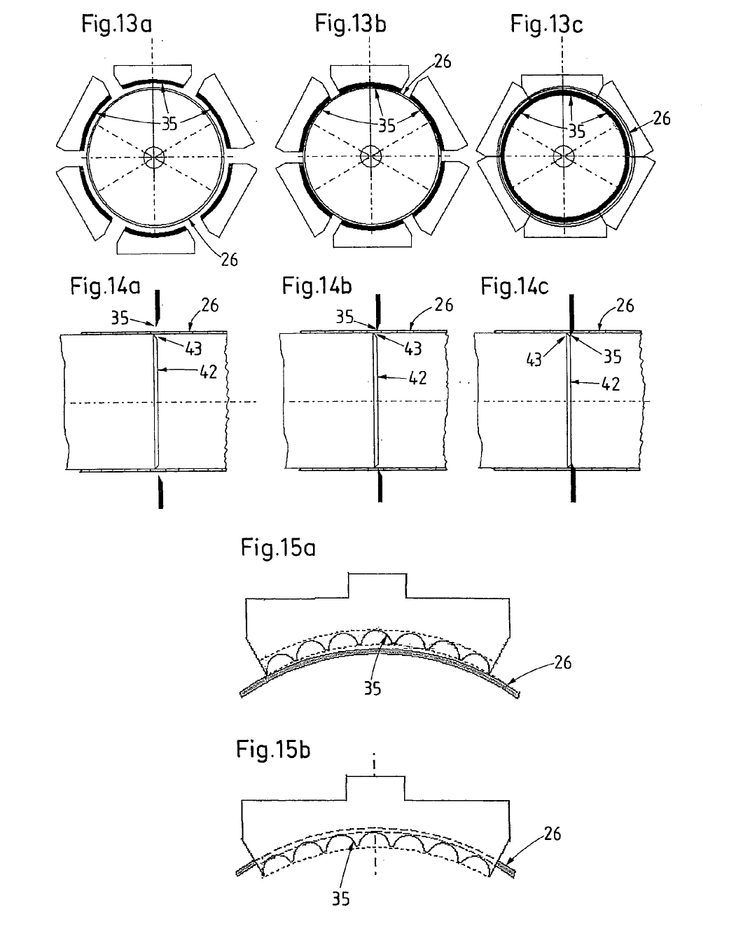

FIGS. 13a, 13b, 13c, 14a, 14b and 14c show the use of cutting edges 35, which extend over segments of a circle, for cutting continuously moved tubes 26. A plurality of cutting edges 35 are provided along the tube's circumference, which may be moved substantially in perpendicular planes to the tube's axis from the exterior in radial direction to the tube's axis, wherein at the end of the cutting movement, the cutting edges 35 are situated radial within the tube's wall and have completed a closed line. Subsequently, the cutting edges are moved again radial to the exterior. With extremely thin-walled metal tubes 26, one may do, in some cases, without moving the cutting edges in the direction of the tube's axis, in which case the extremely short tube advancement, advanced during the cutting procedure, may be somewhat deformed radial to the interior about the backing edge 43. If the tube's advancement were affected by cutting edges fixedly positioned in longitudinal direction of the tube, the cutting edges are moved in longitudinal direction of the tube during cutting. To this end, the drum approach, already described for producing slots, or the approach using guiding devices may be employed, wherein such guiding devices keep the cutting edges in a perpendicular plane to the tube's axis during cutting procedure and, at the same time, move this perpendicular plane with the speed of the tube's advancement.

Example embodiments being thus described, it will be obvious that the same may be varied in many ways. Such variations are not to be regarded as a departure from the spirit and scope of the present invention, and all such modifications as would be obvious to one of skill in the art are intended to be included within the spirit and scope of the following claims.

1. A method for producing a can body including a can shell arranged around a can axis and a can bottom, said method comprising:
moving a metal band in its longitudinal direction towards a severing device;
carrying out severing steps by said severing device to prepare sections of the metal band as can shells with a butt-joined longitudinal laser seam;
carrying out at least one laser step being carried out for forming said longitudinal laser seams of the can shells; and
carrying out connection steps by which a can bottom is fixed to one front side of each can shell,
wherein prior to moving the metal band towards the severing device the metal band, in a printing step, is imprinted with decorative surfaces which in relation to a first direction of the metal band, extend in the direction of the can axis and extend transversely to the first direction in the direction of the can periphery, at least one longitudinal register mark being arranged in an area of each decorative surface, and longitudinal register marks enable controlling the severing steps in such a manner, that the severed sections of the metal band each comprise a complete decorative surface.

2. The method according to claim 1, wherein a primer is applied to the metal band prior to the printing step for printing decorative surfaces, and the primer includes at least one layer.

3. The method according to claim 2, wherein the primer is applied by at least one printing plate of a printing machine.

4. The method according to claims 1, wherein with the printing step, at least one of the printing processes of the group of offset printing, flexo-printing and silk screen printing is used.

5. The method according to claims 1, wherein slots are formed with the printing step on the flat metal band in planes perpendicular to the longitudinal axis of the metal band which, do not extend up to two lateral marginal areas of the metal band, the metal band is continuously formed in a shaping step at a shaping device into a tube by butt joining the lateral edge surfaces of the metal band, and the shaped tube is closed in circumferential direction at the butt joined lateral edge surfaces in a welding step at a welding device by a laser seam, and sections of the closed tube are severed by the severing steps at the severing device wherein preferably in at least one area without a slot, at least one cutting edge is moved from an the exterior towards the tube's axis and after cutting away from the tube's axis, and in particular the at least one cutting edge, during a its cutting movement, is additionally moved together with the tube and is subsequently brought again into position before severing.

6. A method for producing a can body including a can shell arranged around a can axis and a can bottom, said method comprising: moving a metal band in its longitudinal direction;
continuously forming the metal band in a shaping step at a shaping device into a tube by butt-joining the lateral edge surfaces of the metal band;
closing the shaped tube in circumferential direction at the butt joined lateral edge surfaces in a welding step at a welding device by a longitudinal laser seam;
severing, in severing steps at a severing device, sections of the closed tube;
making the sections of the closed tube available as can shells having a laser seam; and
carrying out connection steps by which a can bottom is fixed at one front side of each can shell,
wherein in a treatment area after the welding device and before the severing device an inner coating step is effected by an inner coating device, where a circumferentially closed inner coating is formed at an inner side of the closed tube.

7. The method according to claim 6, wherein during the inner coating step, the inner side of the closed tube is provided with an inner plastic coating supplied by an extrusion nozzle.

8. The method according to claim 6, wherein a layer of bonding agent is applied between the inner side and the inner plastic layer.

9. The method according to claim 1, wherein the metal band is subdivided after the printing step along its longitudinal direction into at least two metal bands, which in transverse direction comprise each only the décor for one can shell, and which are further processed separately in further process steps.

10. The method according to claims 1, wherein at least two metal bands are processed into can shells in lines working in parallel, and the can shells of the lines working in parallel are combined and processed in a device in common for carrying out the connection steps by which a can bottom is fixed at one front side of each can shell.

11. The method according to claims 1, wherein at least one lateral retrenchment is carried out with the metal band in order to form neat and precise lateral surfaces of contact for welding.

12.-15. (canceled)

16. A can body comprising a can shell and a can bottom, the can shell being formed of a metal sheet, which has been severed from a metal band and has been closed by a butt-joined longitudinal laser seam, wherein the can shell includes a decorative surface on an exterior surface of the can shell, and the can bottom is fixed to one front side of said can shell, wherein the decorative surface is formed as a print onto the flat metal band and includes at least one longitudinal register mark, which ensures severing of a section for the can shell from the metal band in such a manner, that the can shell includes a complete decorative surface.

17. A can body, comprising:
a can shell, which includes an inner coating; and
a can bottom, wherein the can shell is formed of a section of a metal band, which is continuously formed into a tube by butt joining the lateral edge surfaces, and is closed in a circumferential direction at the butt joined lateral edge surfaces by of a longitudinal laser seam, and the can bottom is fixed to one front side of said can shell, and wherein the inner coating is a layer closed in the circumferential direction and adhering to the inner side of the closed tube, which covers the longitudinal laser seam, and is severed together with the metal band.

18. A device for producing can body, having
a can shell and a can bottom, said device comprising:
an advancement device;
a severing device; and
a first and a second laser welding device, wherein a metal band is movable by the advancement device in longitudinal direction of said metal band towards the severing device, and the metal band is severable by said severing device in order to prepare sections of the metal band as can shells with a butt-joined longitudinal laser seam produced by said first laser welding device, and said second laser welding device is configured to fix, a can bottom to one front side of each can shell, and
a printing device, that imprints the metal band, with decorative surfaces and with longitudinal register marks, wherein said decorative surfaces in a first direction of the metal band, have a height extension of the can décor in the direction of the can axis and have the circumferential extension of the can décor transversely to said first direction, wherein said longitudinal register marks are arranged in the area of said decorative surfaces and enable control of said severing steps in such a manner, that the severed can shells comprise each a complete decorative surface.

19. The device according to claim 18, further comprising:
a slotting device that forms slots in the metal band in planes perpendicular to the longitudinal axis of the metal band which do not extend up to the two lateral marginal areas of the metal band;
a shaping device which forms the metal band continuously into a tube by butt joining the lateral edge surfaces of the metal band, and the shaped tube is closed in circumferential direction at the butt joined lateral edge surfaces;
a welding device that closes, in a circumferential direction, the shaped tube at the butt-joined edge surfaces by a laser seam; and
a severing device, that severs sections of the closed tube, wherein in the at least one area without a slot, at least one cutting edge is moved from an exterior towards the tube's axis and after cutting away from the tube's axis, and in particular the at least one cutting edge, during its cutting movement, is additionally moved together with the tube and is subsequently brought again in its position before severing.

20. A device for producing a can body having a can shell and a can bottom, said device comprising:
an advancement device;
a shaping device;
a first and a second laser welding device;
a severing device;
an inner coating device, wherein a metal band is moved by the advancement device in longitudinal direction of said metal band towards said shaping device, and said shaping device forms said metal band into a closed shape, wherein said first laser welding device connects the butt-joined lateral edge surfaces of said metal band by a longitudinal laser seam, said severing device, in severing steps, severs sections of the closed tube, and said second laser welding device fixes a can bottom to one front side of each can shell, wherein said inner coating device is arranged in a treatment area after the welding device and before the severing device and forms an inner coating closed in a circumferential direction at the inner side of the closed tube.

21. (canceled)

22. The method of claim 1, wherein the first direction of the metal band is a longitudinal direction.

23. The method of claim 2, wherein the at least one layer includes a bonding coating and an imprintable upper layer with a two component lacquer, the two component lacquer being based on at least one of polyester, a polyurethane, epoxy resins, polyvinylidenefluoride (PVDF), nitrocellulose, and an alkyd resin.

24. The method of claim 3, wherein the primer is applied only in the area of the decorative surfaces.

25. The method of claim 8, wherein the bonding agent is supplied by an extrusion nozzle during the step of inner coating.

26. The method of claim 18, wherein the first direction of the metal band is a longitudinal direction.
